(19) United States
(12) Patent Application Publication
(10) Pub. No.: US 2015/0321593 A1
(43) Pub. Date: Nov. 12, 2015

(54) Cup Holder Support

(71) Applicant: Leslie NORTH, Westfield, NJ (US)

(72) Inventor: Leslie NORTH, Westfield, NJ (US)

(21) Appl. No.: 14/707,351

(22) Filed: May 8, 2015

Related U.S. Application Data
(60) Provisional application No. 61/990,802, filed on May 9, 2014.

(51) Int. Cl. B60N 3/00; B60N 3/10

(52) U.S. Cl. CPC B60N 3/002; B60N 3/102

(57) ABSTRACT

A cup holder support is described and taught. The cup holder support is designed to provide a level, nonslip surface over a cup holder area taking advantage of an existing cup holder. The cup holder support has two main components: a telescoping cup and a platform section. The telescoping cup fits within a slidable track in the underside of the platform allowing for the cup to be placed in variable positions to best conform to the position of the existing cup holder in an automobile. The telescoping cup can also be adjusted to conform to the height required by providing for a locking mechanism that holds the sections of the cup in place. The platform further has at least one hingeable, locking section along an edge that can be used to extend the surface are of the platform to conform to the surrounding area.

### CLAIM OF PRIORITY

This application claims the priority of U.S. Ser. No. 61/990,802 filed on May 9, 2014, the contents of which are fully incorporated herein by reference.

### FIELD OF THE INVENTION

The field of the invention relates to a support for a cup holder, namely a platform or surface that covers a cup. In particular, to a telescoping cup that is removably attached to a covering surface.

### BACKGROUND OF THE INVENTION

Cup holders have seen an increased prevalence in automobiles since first appearing in the 1950s. Around this time, life was becoming more and more fast paced resulting in people finding ways to save time by completing multiple tasks at the same time. Thus, many people began to drink their coffee on their way to work rather than at home. The problem being, initially, that cars were ill equipped for transporting beverages on the go. The existing cup holders were designed to be used at drive-in eateries and attempting to use such as cup holder while the automobile was in motion would result in a mess.

Nowadays, cup holder within the family automobile are a common occurrence with automobiles boating a plethora of holders per vehicle accommodating cups of varying sizes and shapes. Now the issue with cup holders is their ubiquitous nature. They are hard to clean and can get notoriously grimy if not used for any duration of time. Some individuals have proposed covers for cup holder that help limit spills and other messes that may contaminate the cup holders.

However, these covers do not take into account the functional area around the cup holder. Often, they leave the cup holder covered but leave the area unusually shaped and not conducive for keeping materials and other items in place. Thus, there is the need for the technology that allows one to cover a cup holder virtually anywhere, specifically in an automobile, and make the space functional in doing so. Review of related technology:

U.S. Pat. No. 7,301,758 pertains to a storage compartment for a motor-vehicle partition that has an annular vehicle frame set in the partition, a container set in the vehicle frame and having an open side, and a mount releasably retaining the container in the vehicle frame. A cover fittable over the open side is adapted to carry a piece of vehicular accessory equipment, e.g. a cup holder, DVD or CD player, or the like.

U.S. Pat. No. 6,708,938 pertains to a cup holder for use in an automobile. The cup holder is mounted in a console of the automobile. A jaw that serves to lift a cover for the cup holder is integrally formed at one side of an upper surface of the cover. In this cup holder, there is no necessity for employing additional guides in order to hold the beverage can or the beverage can. The cup holder is capable of independently receiving various sized articles with maintaining a good external appearance and it is convenient to use. When a user opens a front cover among the total covers for opening or closing retaining grooves, there is no necessity for opening the back covers.

U.S. Pat. No. 6,409,136 pertains to a holder for a beverage container that has two holding elements which are turnable around two turning axes spaced from one another from a substantially lying position to a substantially standing position and vice versa, so that the holding elements in the substantially standing position have a distance therebetween, which allows insertion of a beverage container between the holding elements, and a coupling transmission which provides an opposite turning movement of the holding elements.

U.S. Pat. No. 5,718,405 pertains to a cup holder for holding beverage containers in the passenger's compartment of a motor vehicle. The holder body is mounted in the passenger's compartment and has a pair of cavities for holding the beverage containers, a cover for covering the cavities, a pair of guide mechanisms for selectively opening and closing the cover, and a retainer assembly mounted on a flange of the holder body. The retainer assembly has a pair of retainers for retaining the beverage containers held in the cavities, and a projection integrally formed with the retainers for abutting against the cover to stop the cover.

Various devices are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE INVENTION

A cup holder support is described and taught having a telescoping cup with a base section, a top section, and at least one sidewall section; and a polygonal platform having an upper surface and a lower surface, wherein the polygonal platform is removably coupled to the telescoping cup.

The telescoping cup is designed and sized to fit within a standard automobile cup holder. Other shapes and sizes may exist to fit into unusually shaped holders. The telescoping cup preferably has a number of sections including a top, sidewall, and base. Each of the sections has an outer wall and an inner wall with a top edge and a bottom edge.

Generally, the cup is shaped so that the diameter of the base section is smaller than the diameter of the top section. The number of sidewalls may vary but there should be about one to about twenty sections per cup. When a pressure is applied to the telescoping cup the top section and the bottom section come together as necessary to aid in providing a level platform. The telescoping cup sections also have a locking mechanism to secure the sections in place relative to one another. The locking mechanism is preferably a rotatable locking mechanism, although other known mechanisms may be employed. Thus, once the height of the cup sections are set by the user, the sections can be rotated thereby locking them into place. If necessary, the telescoping cup should be able to be confined to the height of one section of the cup.

On the upper surface of the platform, there is a non-slip surface such as a silicone or rubber. The telescoping cup can be positioned under the platform enabling the cup to provide support and restrict movement from cup holders in a variety of positions. The platform, as a whole, is sized and shaped to provide an even surface for a cup holder and the surrounding area resulting in generally a substantially square or rectangular shape.

Additionally, the platform has at least one and preferably two hingeable, locking sections. These sections are designed to provide flexibility with regard to the sizing of the platform. When these sections are not required, they can fold underneath the platform without disturbing the position of the apparatus as a whole. When the sections are needed, they are simply rotated out into position and locked into place. By using one or both of the sections, the shape and dimensions of the platform can thereby be changed to suit the needs of the user for a particular application.

In general, the present invention succeeds in conferring the following, and others not mentioned, benefits and objectives.

It is an object of the present invention to provide a cup holder support that can be used in a variety of positions.

It is an object of the present invention to provide a cup holder support that can provide a level surface.

It is an object of the present invention to provide a cup holder support that is durable and inexpensive.

It is an object of the present invention to provide a cup holder support that can be used in a variety of makes and models of automobiles.

It is an object of the present invention to provide a cup holder support that has a non-slip platform surface that can be sized to accommodate the user's needs.

It is an object of the present invention to provide a cup holder support that enables the telescoping cup to be placed in a variety of positions enabling the support to be used with cup holders in a variety of positions.

### BRIEF DESCRIPTION OF THE DRAWINGS

FIG. 1A is a perspective view of the present invention.

FIG. 1B is a side view of the present invention showing the configuration of the cup attached to the platform.

FIG. 2 is a side view of the telescoping cup portion of the present invention.

FIG. 3A is a top view of the platform portion of the present invention with the hinged sections folded underneath the platform.

FIG. 3B is a top view of the platform portion of the present invention with the hinged sections locked outwards.

FIG. 4 is a bottom view of the platform with the telescoping cup affixed to the slidable track.

FIG. 5 is a top view of the present invention used as intended within an automobile console area having a cup holder.

### DETAILED DESCRIPTION OF THE DRAWINGS

The preferred embodiments of the present invention will now be described with reference to the drawings. Identical elements in the various figures are identified, as far as possible, with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

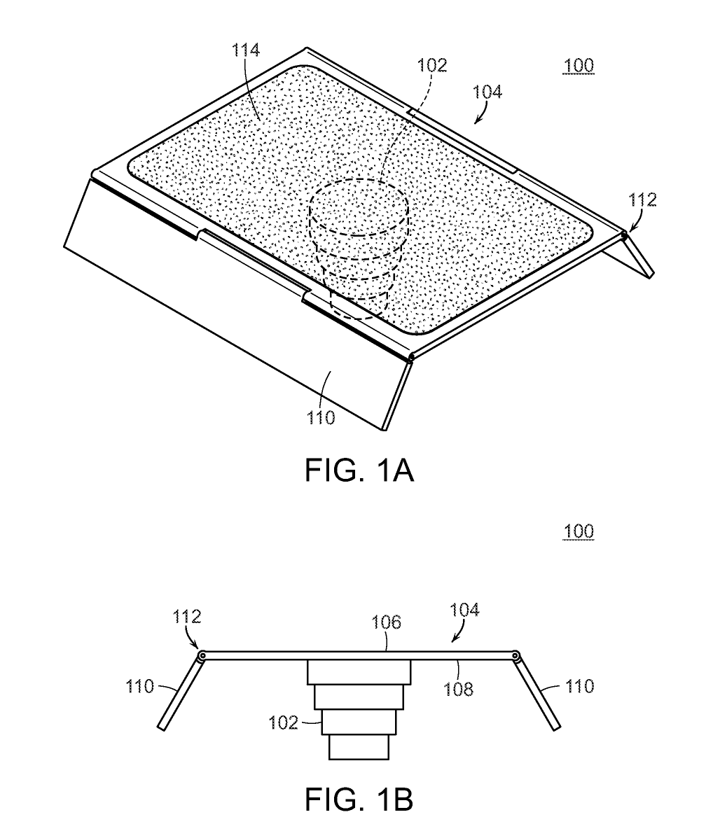

Referring to FIGS. 1A and 1B, there is a cup holder support 100. The cup holder support 100 comprises two main components: a telescoping cup 102 and a polygonal platform 104. The telescoping cup 102 is coupled to the polygonal platform 104. The polygonal platform 104 has an upper surface 106 and a lower surface 108. The upper surface 106 has a nonslip surface 114. At least one area of the polygonal platform 104 has a number of hinges 112. The hinges 112 allow a portion of the polygonal platform 104 to be manipulated independent of the remainder of the platform 104. The hingeable platform section 110 follows at least one lateral edge of the platform 104. The hinges 112 are also lockable. Thus, by moving the hingeable platform section 110 into a position and engaging the lock(s), the hingeable platform section 110 can be held in a particular position.

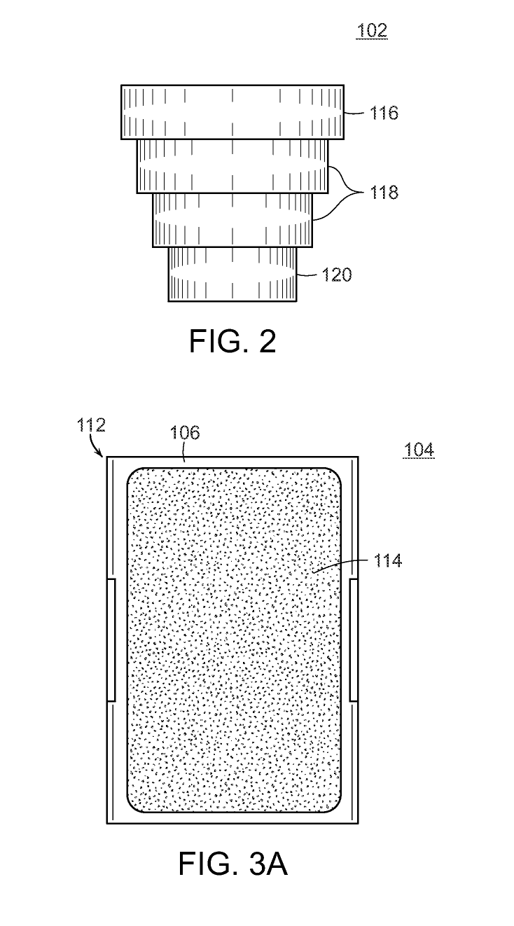

In FIG. 2 there is the telescoping cup 102. The telescoping cup 102 has at least two sections and preferably more. In a preferred embodiment, the telescoping cup 102 has a base section 120, a sidewall section 118, and top section 116. The various sections of the cup 102 can be positioned as needed. Thus, the sections may condense together within the interior of the top section 116. The sections also have a locking mechanism (not shown) that sets the position of the sections relative to one another. The locking mechanism is preferably a rotatable locking mechanism that uses tension or other acceptable mechanics. The base section 120 is the smallest in diameter and is sized to be positionable within most standard cup holders.

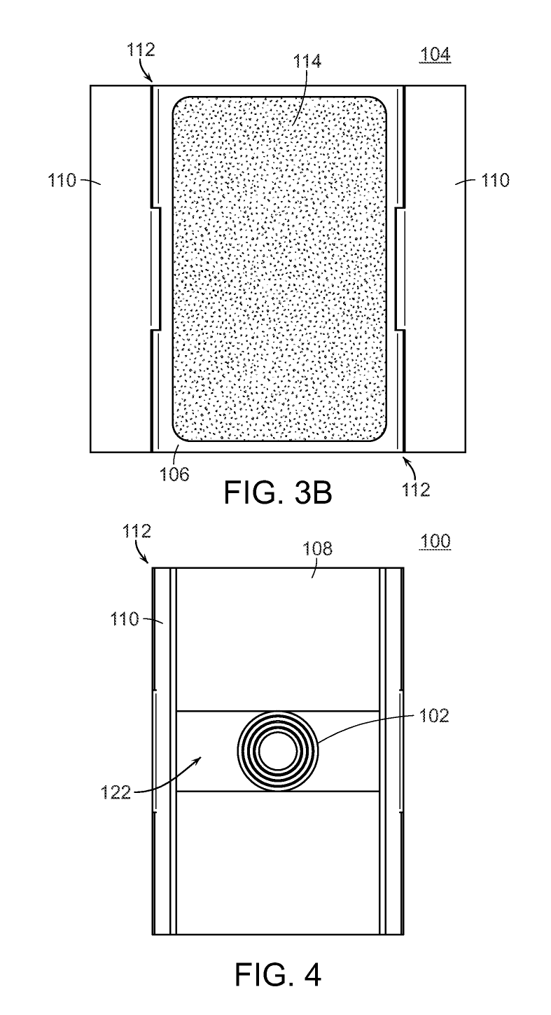

In FIG. 3A, there is a top view of the polygonal platform with the hingeable platform sections 110 folded underneath. Visible are the upper surface 106 of the polygonal platform 104, the hinges 112, and the nonslip surface 114. With the hingeable platform sections 110 folded underneath the main polygonal platform 104, the dimensions have been narrowed. In FIG. 3B, the polygonal platform 104 has both of the hingeable platform sections 110 positioned level with the platform 104 and secured into place. Either one or both of the hingeable platform sections 110 may be placed in a variety of positions independent of one another.

In FIG. 4, there is a bottom view of the polygonal platform 104. Visible are of the lower surface 108 of the platform 104 and the telescoping cup 102 and the slidable track 122. The telescoping cup 102 fits within the slidable track 122 and is secured in place by this fitting. The slidable track 122 provides for movement of the telescoping cup 102 to accommodate a variety of cup holder positions. The slidable track 122 may be oriented in a number of fashions depending on the exact specifications or customer desires of the invention. Thus, the slidable track 122 may provide for left/right and up/down movement. The may also only be capable of one direction of movement or one plane of movement for which the telescoping cup 102 is capable of using. The hingeable platform sections 110 can move freely, but should be of a design that does not interfere with the movement of the telescoping cup 102 or the slidable track 122.

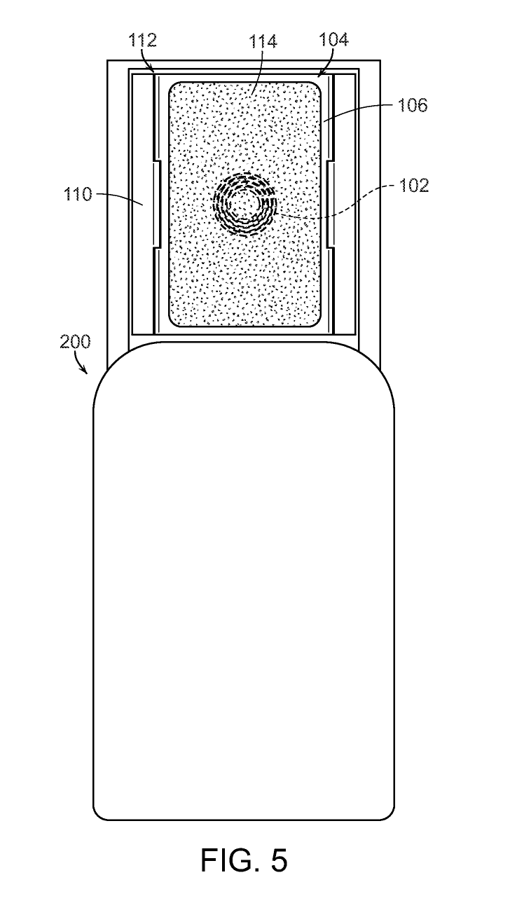

In FIG. 5, the cup holder support 100 is positioned as intended, in this case in an automobile console 200. The automobile console 200 typically has a variety of storage areas for food, drinks, and other miscellaneous supplies. Typically, the area surrounding the cup holder possesses an uneven surface. The telescoping cup 102 is positioned within the cup holder and the polygonal platform 104 covers the surrounding environment. Upon an upper surface 106 of the platform 104 is a nonslip surface 114. This provides for a functional area that helps to prevent items from becoming displaced throughout the normal course of driving in traffic. In this particular example, one of the two hingeable platform sections 110 is secured in a position in the same plane as the platform 104. The other hingeable platform 110 is folded underneath the platform 104 as the space requirements do not require its use.

As shown in FIGS. 1-2, the telescoping cup 102 can have a number of sections that are sized for use within a cup holder. The sections can range from at least two to about twenty and more preferably have about two to about ten sections and most preferably have about two to about five sections. The sections are a number of concentric circles of varying diameters. The base section 120 has the smallest diameter and the top section 116 has the largest diameter. The remaining section(s) interspersed between the top section 116 and the base section 120 are sized to be slidably engaged to the section above and below. Each of the sections, except the top section 116, are capable of sliding up within the perimeter of the larger section. This enables the telescoping cup 102 to change height dependent on the height required by the cup holder.

Further, the telescoping cup 102 has a locking mechanism that prevents the sections from moving from the desired configuration. The type of locking mechanism may vary, but is preferably a rotatable locking mechanism where rotating each of the sections independent of one another enables the rotated section to “lock” into place. Thus, some sections may be locked while others are free to move. In some instances, the base section 120 may be positioned fully within the section located above it. This provides for a larger section to fit in cup holders with a larger circumference. Additionally, the locking mechanism can be any combination of latches, tabs, springs, or the like that are capable of preventing movement of the sections.

The telescoping cup 102 is preferably fashioned from a plastic material that is resistant to breakage. This creates a lightweight item that is safe to use in a number of settings. Examples of suitable plastics are polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or any combination thereof. Additionally, some resins or composites or lightweight metals may be used. In some instances a combination of materials can be used such as a plastic coated metal.

The polygonal platform 104 is shaped to generally accommodate a user's need to create a flat area for use where there is none. The polygonal platform 104 should be fashioned from substantially the same materials as the telescoping cup 102 as listed above. The platform 104 may have a number of shapes and can have between about three and about ten lateral edges and more preferable between about three and about six lateral edges. In the preferred embodiment, the polygonal platform 104 is substantially square in shape. Thus, the dimensions may range from about 7.5 cm (3 inch) to about 30 cm (12 inch) in length and about 7.5 cm (3 inch) to about 30 cm (12 inch) in width.

Preferably the polygonal platform 104 is about 23 cm (9 inch) in height and about 18 cm (7 inch) in width. The platform 104 may also be about 18 cm (7 inch) in height and about 23 cm (9 inch) in width. In addition, the dimensions of the polygonal platform 104 can further be modified by the inclusion of a number of hingeable platform sections 110.

The hingeable platform sections 110 are designed to increase the functionality of the cup holder support 100 as a whole. The hingeable platform sections 110 can range in number depending on the number of lateral edges of the platform 104. The number of hingeable platform sections 110 can range from none up to the number of edges on the platform 104. In some instances, there are lateral edges that do not have a hingeable platform section 110. These sections are secured to the platform 104 by hinges 112. The hinges 112 provide for about 180° of motion and more preferably about 270° of motion with the zero point measured with the sections folded underneath the platform 104. There is at least one hinge 112 at each end of the lateral edge and in some cases may include more hinges 112 or comprise one hinge 112 extending the length of the lateral edge. When not in use, these sections are preferably stored underneath the platform 104. When their use is desired, the sections 110 are folded out and into position.

The position(s) may vary and could sit in the same plane as the platform 104. Here, the hingeable platform sections 110 would expand the area of the platform 104. The sections 110 are about 2.5 cm (1 inch) to about 10 cm (4 inch) and preferably about 3.8 cm (1.5 inch). Thus, having the hingeable sections 110 sit in the same plane as the platform 104 the sections would preferably add about 3.8 cm (1.5 inch) to each edge where they are extended. In order to sit in this manner, the sections need to be supported. The hingeable sections 110 can be locked or secured into place by way of the hinge(s) 112 or the platform 104. The hinges 112 may have the functionality to be locked into a particular position which would allow the sections 110 to be placed in any number of positions. Alternatively, the sections 110 may be able to slidably engage the platform 104 and become secured with a complimentary edge that fits that of the platform 104 thereby holding them in position. The hingeable sections 110 may be able to be positioned substantially perpendicular, or at least above the plane of the platform 104. Thus, a cup holder support 100 that has hingeable sections 110 along all the lateral edges of the platform 104 may be able to serve as a “dish” or aid in retaining objects contained within beyond providing a nonslip surface 114.

As shown in FIGS. 3-4, the upper surface 106 and the lower surface 108 of the polygonal platform 104 each has unique features that contribute to the cup holder support 100 functionality. The upper surface 106 has a nonslip surface 114. The nonslip surface 114 can comprise a number of different materials that may be disposed of along the top of the surface or may be integrated with the surface or may wholly comprise that upper surface 106. Such materials may be neoprene, rubber, silicone, or the like or any combination thereof.

The lower surface 108 has a slidable track 122. The slidable track 122 may comprise the entire lower surface 108 or have a definitive channel area(s). The slidable track 122 engages the telescoping cup 102 and enables it to change position respective to the polygonal platform 104. The platform 104 can then be shifted to the right/left/up/down to fit the needs of the user accordingly. There can be a mechanism or position which enables the telescoping cup 102 to be removable from the slidable track 122. The lower surface 108 may be comprised of the same material or a different material as the upper surface 106.

The cup holder support 100 has been shown and described for use in an automobile cup holder. However, one can appreciate that the cup holder support 100 can be used in a variety of settings and wherever a cup holder may be found. The cup holder support 100 can be used on sofas/couches, chairs, tables, and other vehicles such as boats, recreational vehicles (RVs) and the like without deviating from the description herein.

What is claimed is:

1. A cup holder support comprising:
a telescoping cup comprising,
a base section,
a top section, and
at least one sidewall section,
wherein each of the top, base, and sidewall sections have a locking mechanism and are slidably positionable relative to one another; and
a polygonal platform having an upper surface and a lower surface,
wherein the lower surface of the polygonal platform is slidably coupled to the telescoping cup allowing the cup to be variably positioned within the bounds of the platform.

2. The cup holder support of claim 1 wherein the upper surface comprises a non-slip surface.

3. The cup holder support of claim 1 wherein the base section and the top section compresses together upon an upwards or downwards external pressure.

4. The cup holder support of claim 1 wherein the telescoping cup has about one to about ten sidewall sections.

5. The cup holder support of claim 4 wherein there are three sidewall sections.

6. The cup holder support of claim 2 wherein the non-slip surface is a rubber, silicone, or the like.

7. The cup holder support of claim 1 wherein the polygonal platform is sized to appropriately cover and provide an even surface to an existing cup holder.

8. The cup holder support of claim 1 further comprising at least one hingeable, locking section located along a lateral edge of the polygonal platform.

9. A cup holder support comprising:
a telescoping cup having at least two sections with each section having an outer wall and inner wall with a top edge and a bottom edge, the telescoping cup comprising,
a substantially circular base section being appropriately sized to fit within the confines of an automobile cup holder,
a top section having a larger diameter than the base section, and
three sidewall sections slidably coupled to one another and coupling the base section to the top section,
wherein the sections have a locking mechanism that secures the cup sections in place once positioned; and
a substantially square platform having an upper surface and a lower surface,
wherein the platform has a slidable track disposed on the lower surface and a non-slip surface disposed on the upper surface,
wherein the platform has at least one hingeable, locking section, and
wherein the telescoping cup is coupled to the slidable track on the lower surface of the platform.

10. The cup holder support of claim 9 wherein the base section has the smallest diameter and the top section has the largest diameter of the cup sections.

11. The cup holder support of claim 10 wherein the sections of the telescoping cup all fit within the confines of one section once collapsed.

12. The cup holder support of claim 9 wherein the platform is sized to cover irregular surfaces surrounding the cup holder of an automobile.

13. The cup holder support of claim 9 wherein the substantially square platform has two hingeable, locking sections.

14. The cup holder support of claim 13 wherein the hingeable, locking sections are located on opposing sides of the platform.

15. The cup holder support of claim 9 wherein the locking mechanism is a rotatable locking mechanism.

16. The cup holder support of claim 15 wherein each cup section can be rotatably locked independent of the other sections.
